(19) United States
(12) Patent Application Publication
(10) Pub. No.: US 2011/0101054 A1
(43) Pub. Date: May 5, 2011

(54) CARGO SLING SYSTEMS

(76) Inventor: Daria Wicinski, McHenry, IL (US)

(21) Appl. No.: 12/901,802

(22) Filed: Oct. 11, 2010

Related U.S. Application Data
(60) Provisional application No. 61/257,703, filed on Nov. 3, 2009.

(51) Int. Cl. B60R 7/00

(52) U.S. Cl. 224/275

(57) ABSTRACT

A cargo sling device comprising: a removably attachable strap made from pliable material suitable to fit around a perimeter of a vehicle seat back; the removably attachable strap is used to safely restrain at least one item of interior cargo such as Kleenex®, baby supplies, lunch boxes, groceries, purses and other such items. In certain embodiments the removably attachable strap comprises a one-piece construction and in alternate embodiments comprises a bifurcated construction wherein the removably attachable strap comprises a first end and a second end. The removably attachable strap preferably comprises an elastic material suitable to stretch around the seat back and the secured items. The multi-piece construction embodiment of the removably attachable strap preferably comprises at least one fastener such as a zipper, snap, clip, button or other fastener(s). The fastener(s) may be located in the front and/or the back when installed. The zipper or other fastener may be used to couple the first end and the second end of the removably attachable strap together.

### CROSS-REFERENCE TO RELATED APPLICATION

The present application is related to and claims priority from prior provisional application Ser. No. 61/257,703, filed Nov. 3, 2009 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of slings and more specifically relates to slings for use in holding interior cargo.

2. Description of the Related Art

Many individuals in modern society use vehicles to transport themselves and items between various locations. Often individuals store various personal items such as boxes of Kleenex®, baby supplies, lunch boxes, groceries, purses and other such items.

These items may fall on the floor during vehicular maneuvers creating a mess. Further, it may be dangerous to have loose items sitting on seats in a moving vehicle for instances when the driver has to apply the brakes hard or take a sharp turn, causing the unsecured items to fall off the seat spilling on to the floor of the vehicle. This may be extremely distracting to the driver as well as potentially dangerous. Many drivers may attempt to retrieve the items causing them to divert their attention from the task of driving causing a frustrating and potentially dangerous situation. Kleenex® boxes and like items have been known to decapitate drivers or passengers when hurled forward in rear end collisions. Therefore a need exists for a device that vehicle owners could use to secure their personal belongings reliably in place during periods of vehicular excursions.

Relatedly, many drivers utilize electronic devices, such as cellular telephones, PDAs, electronic music devices, such as MP3 players, or the like, in vehicles or simply wish to have access to electronic devices if needed. Electronic devices may further be charged using a vehicle's cigarette lighter or other power receptacle. Many vehicles do not have a location for holding an electronic device within reach of a driver for easy access, or while charging.

Other potential problems include transporting large sports bottles or “super-sized” drink cups that do not fit within factory-installed cupholders. Moreover, vases may be transported in vehicles, and may contain water and flowers therein. It may be difficult for a driver to hold a vase full of water, flowers or any other item, in a vehicle without tipping the same. Moreover, although it is generally known to have pockets disposed within seat backs, many of these pockets are not adequate for holding a large amount of items, or large items.

Various attempts have been made to solve the above-mentioned problems such as those found in U.S. Pat. Nos. 7,309,102; 5,354,119; 6,533,350; 6,896,164; 6,742,837; and 4,165,828. This prior art is representative of slings. None of the above inventions and patents, taken either singly or in combination, is seen to describe the invention as claimed.

Ideally, a cargo sling system should operate reliably to provide safety for drivers and occupants of vehicles and be manufactured at a modest expense. Thus, a need exists for a safe, reliable cargo sling system to avoid the above-mentioned problems.

### BRIEF SUMMARY OF THE INVENTION

In view of the foregoing disadvantages inherent in the known cargo sling art, the present invention provides a novel cargo sling system. The general purpose of the present invention, which will be described subsequently in greater detail is to provide safety and convenience for drivers and occupants of vehicles.

A cargo sling device is disclosed herein comprising: a removably attachable strap being made from pliable material suitable to fit around a perimeter of a vehicle seat back. The removably attachable strap is used to safely restrain at least one item of interior cargo such as Kleenex®, baby supplies, lunch boxes, groceries, purses and other such items. In certain embodiments the removably attachable strap comprises a one-piece construction and in alternate embodiments comprises a bifurcated construction wherein the removably attachable strap comprises a first end and a second end. The removably attachable strap preferably comprises an elastic material suitable to stretch around the seat back and the secured items. The device may have a height dimension of about 10 inches and may be ordered in at least one user-preferred color or combinations thereof. In certain embodiments the strap may include at least one front-pocket for holding suitable electronic devices and other smaller items. The bifurcated construction embodiment of the removably attachable strap preferably comprises at least one fastener such as at least one zipper, snap, clip, button or other suitable fastener. The fastener(s) may be located in the front and/or the back when installed. The zipper or other fastener may be used to couple the first end and the second end of the removably attachable strap together.

A kit is described herein having the removably attachable strap, and at least one pocket. Various combinations of colors, pockets and straps may be used.

Next, a method of using a cargo sling device to secure interior cargo is disclosed comprising the steps of: installing the removably attachable strap around a perimeter of a vehicle seat back; and inserting at least one piece of interior cargo in the cargo sling device for suitable and safe securement. The method may also have the installing step including zipping the first and second end of the removably attachable strap into a coupled relationship suitable to elastically-secure the piece(s) of interior cargo.

The present invention holds significant improvements and serves as a cargo sling system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, cargo sling systems, constructed and operative according to the teachings of the present invention.

FIG. 1 shows a perspective front view illustrating a cargo sling in an in-use condition according to an embodiment of the present invention.

FIG. 2 is a perspective side view illustrating the cargo sling in an in-use condition according to an embodiment of the present invention.

FIG. 3 is another perspective front view illustrating the cargo sling in an in-use condition according to an embodiment of the present invention.

FIG. 4 is yet another perspective front view illustrating the cargo sling in an in-use condition according to an embodiment of the present invention.

FIG. 5 is a flowchart illustrating a method of use for the cargo sling according to an embodiment of the present invention.

The various embodiments of the present invention will hereinafter be described in conjunction with the appended drawings, wherein like designations denote like elements.

### DETAILED DESCRIPTION

As discussed above, embodiments of the present invention relate to a sling device and more particularly to a cargo sling system 100 as used to improve safety and convenience for drivers and occupants of vehicles. Cargo sling 110 comprises stretch fabric band that fits over vehicle seat(s) 120 to hold secure interior cargo 130 including purses, groceries, papers and other such items while a vehicle is in motion. The present invention allows drivers to focus on the road knowing that their belongings will not fly off vehicle seat(s) 120 when the brakes are applied or when going around a sharp curve.

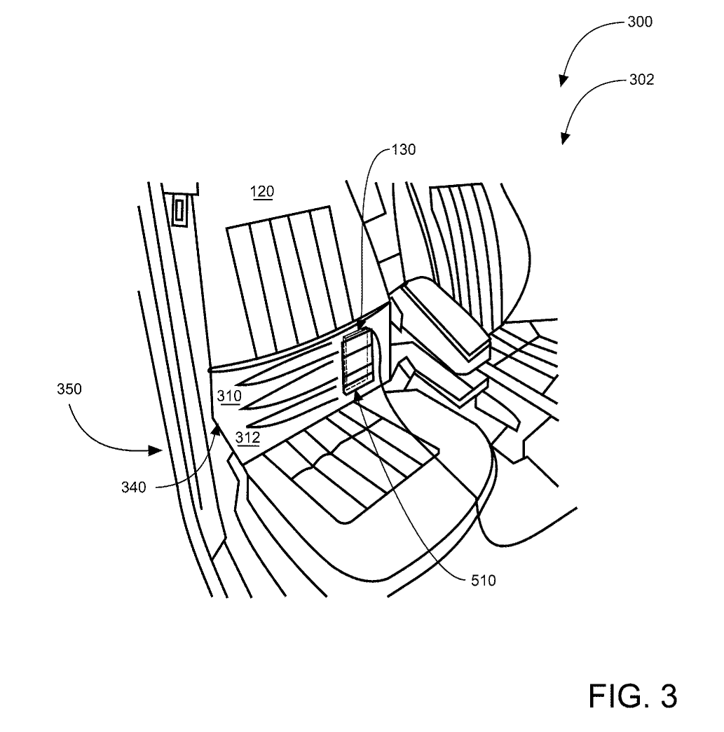

Cargo sling 110 when in non-use periods does not need to be removed due to the fact that cargo sling 110 substantially conforms to vehicle seat(s) 120 allowing a person to sit and lean back against it without causing discomfort. Further, cargo sling 110 may also be used to clip cellular phones thereto or hold music devices, as shown in FIG. 3. Vehicle owner(s) may realize benefit from this safe and convenient novel device, as discussed previously it may be dangerous to have loose items (unsecured) sitting on vehicle seat(s) 120 in a moving vehicle. If the driver has to apply the brakes quickly or take a sharp turn, unsecured items may readily fall off vehicle seat(s) 120 spilling on to the floor of the car. Not only does this create an unfortunate mess, it may also be extremely distracting to the driver. Many drivers may attempt to pick the items up causing them to divert their attention from the road. This can be a frustrating and potentially dangerous situation. Therefore a need exists for a device that vehicle owners could use to secure their personal belongings in a safe manner. Cargo sling 110 is a convenient device for vehicles that suitably secures consumer's personal belongings in place.

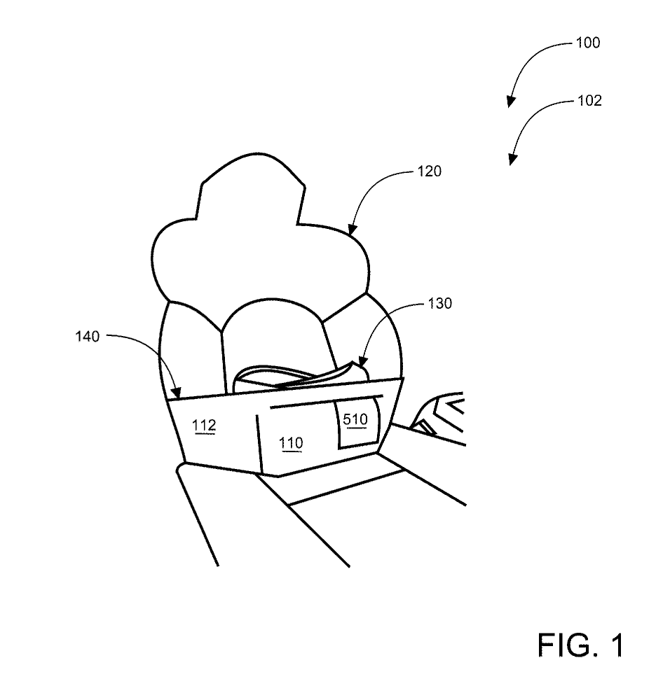

Cargo sling 110 may comprise removably attachable strap 112. An embodiment, as shown in FIG. 1, comprises removably attachable strap 112 that is made of a circular piece of soft, stretchy material. Another embodiment of the present invention may be manufactured such that one side is made from a standard material and the other side having elastic material or straps. Materials used are preferably suitably sturdy and durable to vertically restrain purses and groceries to vehicle seat 120. In this way the present invention is designed with inherent longevity and thereby provides a cost-effective solution to the above-mentioned problems. Dimensions may measure approximately 7-10″ wide (in height when coupled to vehicle seat 120) by 15″ long or other sizes that allow the device to be compatible with most OEM captain chairs (vehicle seat 120) found in vehicles. Cargo sling 110 may be available in a variety of colors that would accommodate both masculine and feminine tastes and may also be available to match with leather versions of vehicle seat 120. Cargo sling 110 may be also referred to as an auto secure band.

Referring more specifically to the drawings by numerals of reference there is shown in FIG. 1, a perspective front view illustrating vehicle seat 120 in an in-use condition 102.

Within the present invention, cargo sling system 100 comprises at least one cargo sling 110 comprising: a removably attachable strap 112 being preferably made from pliable material suitable to fit around a perimeter of a back of vehicle seat 120. Removably attachable strap 112 is suitably configured to fit around a perimeter of a back of vehicle seat 120 wherein seat back 120 extends vertically through removably attachable strap 112. In this way the present invention is held in stasis to vehicle seat 120 when in use (herein enabling in-use condition 102). Removably attachable strap 112 forms a securing pocket in combination with seat back and a seat cushion (vehicle seat 120). As shown, removably attachable strap 112 optionally includes at least one exterior pocket 510 for holding a second piece of interior cargo. The exterior pocket 510 may preferably be disposed in a front of the removably attachable strap 112 when disposed around a vehicle seat 120. However, the exterior pocket 510 may also be disposed in a back of the removably attachable strap 112 when disposed around a vehicle seat 120, thereby providing a storage area for individuals sitting in a back seat of the vehicle, or simply to provide extra storage space. Of course, more than one exterior pocket may be disposed in the removably attachable strap for storing multiple items therein.

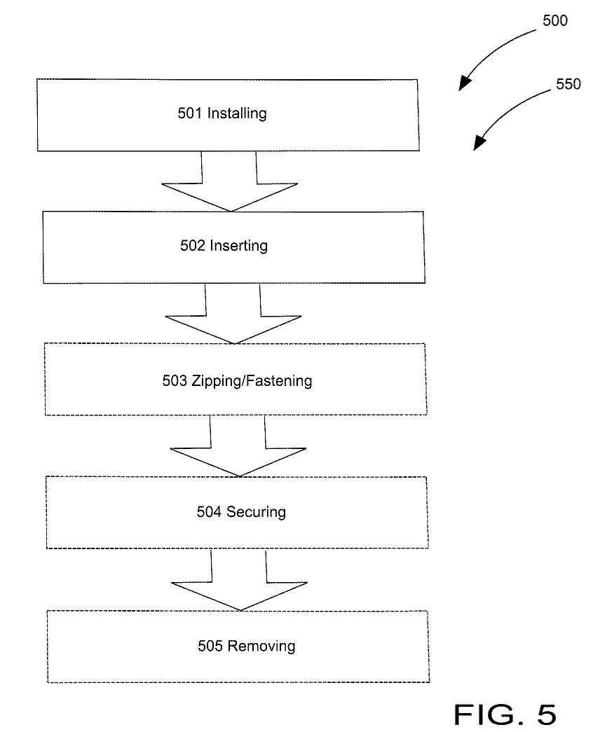

The removably attachable strap 112 may be used to elastically restrain at least one item of interior cargo 130 in securing pocket, item of interior cargo 130 preferably set adjacent the seat back on the seat cushion. Removably attachable strap 112 may be used to restrain at least one first and/or second item of interior cargo 130, separately or in combination as shown in the various FIGS. 1-4. A method of use 500 is shown in flowchart 550 in FIG. 5.

Removably attachable strap 112 within the embodiment at least shown in FIG. 1 comprises a one-piece construction 140. It should be noted that the removably attachable strap 112, and in the other embodiments described herein, may be made from several pieces of material together in a multi-piece construction. In other embodiments removably attachable strap 112 may comprise at least one bifurcated construction 240. The first embodiment as shown in FIG. 1 comprises removably attachable strap 112 that is made of a one-piece undivided circular piece of soft, stretchy fabric material. Within this particular embodiment the device does not contain a multitude of elastic bands (for example it does not comprise edge-mounted reinforcement elastic bands). As shown, the one-piece elastic construction has a profile such that removably attachable strap 112 comprises a height of less than half of the seat back to provide a lower center of gravity, whereby inherent safety is improved.

Removably attachable strap 112 within the preferred embodiments comprises at least one elastically-stretchable fabric material, such as nylon (synthetic polymer), spandex, Lycra® or other such suitable thermoplastic silky material. Upon reading this specification, it should be appreciated that, under appropriate circumstances, considering such issues as user preferences, design preference, structural requirements, marketing preferences, cost, available materials, technological advances, etc., other sling materials and arrangements such as, for example, rubber, Synthetic polyisoprene, Polybutadiene, non-elastic materials, different polymers or combinations thereof, other suitable thermoplastic and/or thermoset polymers, etc., may be sufficient.

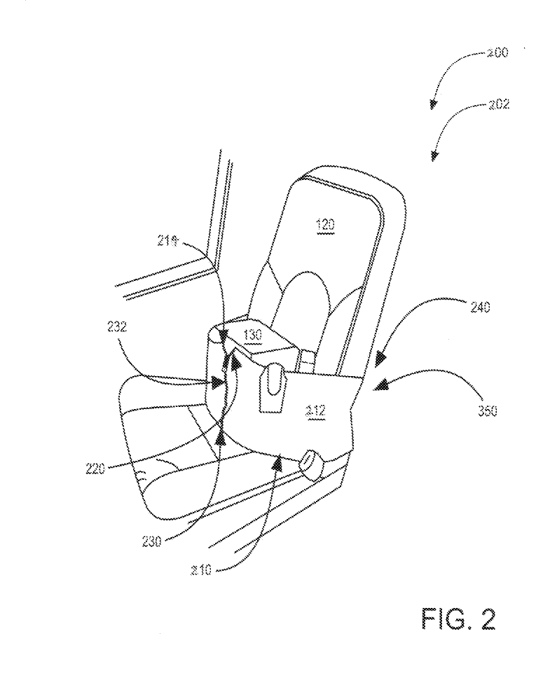

Referring now to FIG. 2, a perspective side view illustrating cargo sling 210 in an in-use condition 202 according to an embodiment of the present invention.

Cargo sling 210 of cargo sling system 200 comprises removably attachable strap 212. Removably attachable strap 212, as mentioned previously may have a bifurcated construction 240 wherein said removably attachable strap 212 comprises a first end 214 and a second end 220. Removably attachable strap 212 may comprise a height dimension of about ten inches, however the height may be greater than or less than ten inches in certain embodiments and according to user-preference. It is preferred that the present invention not comprise a height of greater than ½ of the seat back to maintain a lower center of gravity. Further, removably attachable strap 212 may comprise at least one user-preferred color or combination thereof. Removably attachable strap 212 within this particular embodiment comprises at least one fastener 230. Fastener 230, as shown, preferably comprises at least one zipping means, herein embodied as zipper 232. Zipper 232 is used to couple first end 214 and second end 220 of removably attachable strap 212. In this way the present invention may be fashioned to form an uninterrupted looped device via the fastener 230. Those with ordinary skill in the art will now appreciate that upon reading this specification and by their understanding the art of fibers, attaching means as described herein, methods of construction will be understood by those knowledgeable in such art. For example, fastener 230 may be a hook-and-loop fastener, buttons, snaps, or any other fastening means apparent to one of ordinary skill in the art.

To accommodate use of cargo sling 210 in vehicles with stationary armrests, or in circumstances where cargo sling 210 is made of material that isn't as ‘stretchy by nature’ (leather-look, nylon, stretchy fleece, etc) the device may be secured together via a Velcro® hook-and-loop fastener and/or fastener 230 and/or zipper 232. In other embodiments (not shown), a cargo sling system 100 of the present invention may comprise an ‘all-round pocket’, basically two cargo slings of the present invention sewn together at the bottom, with an inside cargo sling about ½ inch to about 1 inch higher than the outer piece. The outer piece having a top, folded down to create about a ½ inch to 1 inch cuff, for easy access and pulling open of the ‘all-round pocket’. A plurality of vertical seams may be sewn to retain the correct shape and usefulness thereof. In a preferred embodiment, four vertical seams are sewn to retain the correct shape and usefulness thereof and to create four equal front-pockets around the cargo sling device.

The present invention may also be used for other applications such as for holding items such as pizza boxes during pizza delivery securely on vehicle seat(s) 120 to preserve the integrity of such comestible products. In this and other applications, the removably attachable strap as described herein may comprise a plurality of removably attachable straps that may be used in combination to hold the designated items from the bottom, middle and top portions. Specifically, the plurality of removably attachable straps of the present invention may be stacked to provide different an separate holding areas at different heights so as to hold a single item having smaller and/or larger sections, or multiple items stacked atop one another of different sizes.

Further, although many vehicles have drink/cup holders, many larger or odd-shaped containers such as thermoses, flower vases, and other like objects do not fit neatly into these holders, the present invention may provide suitable securing means for these items as well due to its elastic form-fitting nature. In other embodiments, the present invention may be used to hold a pillow or other comforting/back-support means for lumbar support for the driver and/or passenger(s). Cargo sling 110 may also be used for a variety of other applications such as to hold secure on the back of vehicle seat 120, pouches and pockets for holding more personal items. In certain instances headrests on vehicle seats 120 may provide an anchor point for the cargo sling of the present invention.

In the event where a beverage or baby bottle needs to be kept hot or cold, a thermal liner can be added in one or more of front-pockets 510 to hold a cold or hot pack in place, (preferably on the driver's side for easy access to the beverage held in place against vehicle seat(s) 120, as shown in FIG. 3). Preferably, the thermal pocket may be in front of the thermos. Generally, interior cargo 130 may be referred to as first and second (interior cargo 130), first referring to items substantially secured in confines of securing pocket and second items as those being stored in front-pocket 510.

Referring now to FIG. 3, showing another perspective front view illustrating cargo sling 310 in an in-use condition 302 according to an embodiment of the present invention of FIG. 1.

Removably attachable strap 312 within this present embodiment may comprise at least one front-pocket 510. Front-pocket 510 may be used to substantially secure and/or provide a mounting point for at least one portable electronic device, as shown, or to contain various small items to effectively prevent them from becoming misplaced. In this way the present invention provides a means whereby a driver may have convenient access to his/her electronic device(s) while using and/or the electronic device is being charged. Front-pocket 510 may also be sized such that it fits the electronic device held therein in a frictional relationship in a vertical position. In certain embodiments, front-pocket 510 may be positioned on the left side of removably attachable strap 312 and may comprise stitching on the left and bottom of front-pocket 510, allowing the right side of front-pocket 310 to be fastened via hook-and-loop (Velcro®) or other such suitable fastening means (for ease of access to a driver of the vehicle, for example). Hook-and-loop fasteners may allow ease of insertion or removal of electronic devices, although any other fastener may be utilized as apparent to one of ordinary skill in the art.

Front-pocket 510 is preferably designed and sized such that it is easily accessible by the driver and that it is able to accommodate charging plug(s) for the electronic devices as well, yet providing a snug-fit while retaining the electronic device within front-pocket 510. Cargo sling system 300 may also comprise kit 350 having removably attachable strap 312, and at least one front-pocket 510. Cargo sling system 300 may be manufactured and/or sold as kit 350. Cargo sling system 300 may be manufactured and provided for sale in a wide variety of sizes, from a wide variety of materials (leather-look in the present figure, other fabrics in other figures) and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

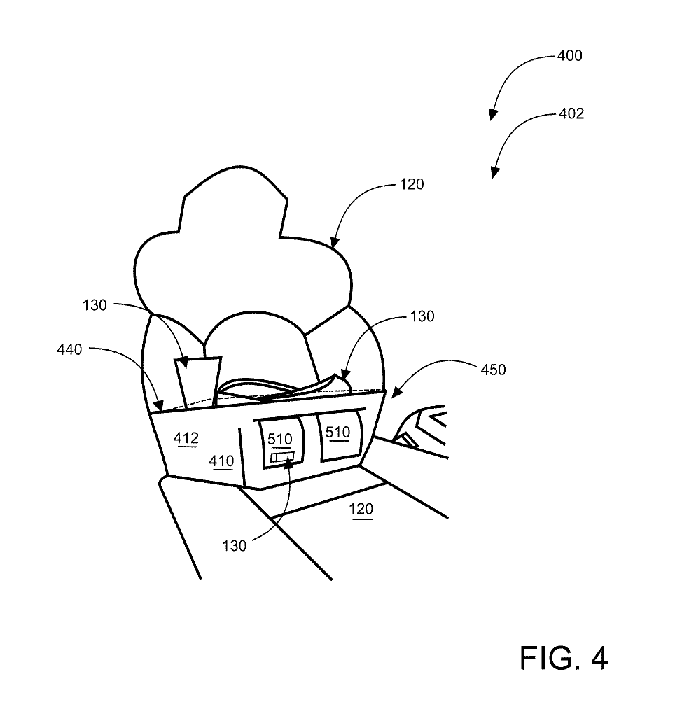

Referring now to FIG. 4, showing yet another perspective front view illustrating cargo sling 410 in an in-use condition 402 according to an embodiment of the present invention.

The device of the present invention, cargo sling 410 comprises a removably attachable strap 412 preferably being elastic made from pliable fabric material suitable to fit around a perimeter of a back of vehicle seat 120, with a height dimension of, preferably, about 10 (ten) inches (although removably attached strap 412 may be any size), available in at least one user-preferred color and/or pattern having at least one front-pocket 510 (exterior pocket). Preferably, the removably attachable strap 412 is used to elastically-restrain at least one item of interior cargo 130. The present figure shows a plurality of front-pockets 510 as may be included in cargo sling system 400. Further, a dotted line is used to illustrate how cargo sling 410 fits around the reverse side of vehicle seat 120. It should be appreciated that cargo sling 410 within the scope of the present invention may also be joined on the reverse side or attached via various fastening means for example seat belts may be used, ties, clips, buttons, clasps and other such securing and/or fastening means.

Referring now to FIG. 5, showing a flowchart 550 illustrating a method of use 500 for cargo sling system as described herein, according to an embodiment of the present invention.

A method of using a cargo sling device of the present invention to secure interior cargo comprises the steps of: step one 501: installing a removably attachable strap of the present invention around a perimeter of a back of a vehicle seat; and step two 502: inserting (thereby substantially elastically-securing) at least one first piece of interior cargo in the removably attachable strap, as described herein, the removably attachable strap of the present invention forming a pocket with the vehicle seat to restrain the first piece of interior cargo.

The installing step may further include step three 503: optionally zipping (or otherwise fastening) a first end and a second end (respectively) of said removably attachable strap of the present invention into a coupled relationship suitable to elastically-secure the at least one piece of interior cargo.

The method 500 may further comprise step four 504: securing an electronic device into or to front-pocket, as described herein (the front-pocket may be sewn on three sides with Velcro® on one side) and an electronic device (i.e., a second item of interior cargo) may be in a charged or charging condition. Step five 505 may comprise removing the cargo sling device of the present invention from the back of vehicle seat and storing in a folded condition. The present invention provides that the cargo sling, as described herein, may stay intact on the vehicle seat when in an in-use condition or in a non-use condition. An individual may sit against the cargo sling device when in a non-use condition because the present invention does not affect the use of vehicle features such as seat belts or other like seat components and does not create an uncomfortable condition to the individual since the cargo sling device comprises soft pliable material.

It should be noted that steps 503, 504 and 505 are optional steps and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A cargo sling device comprising:
a removably attachable strap made from pliable material suitable to fit around a perimeter of a seat back wherein said seat back extends vertically through said removably attachable strap;
wherein said removably attachable strap forms a securing pocket when in combination with said seat back and a seat cushion;
wherein said removably attachable strap further includes at least one exterior pocket;
wherein said removably attachable strap is used to elastically restrain at least one first item of interior cargo in said securing pocket; and
wherein said exterior pocket may separably and accessibly hold a second item of interior cargo.

2. The cargo sling device of claim 1 wherein said removably attachable strap comprises a one-piece elastic construction having a profile such that said removably attachable strap comprises a height of less than half of said seat back thereby providing a low center of gravity.

3. The cargo sling device of claim 1 wherein said removably attachable strap comprises a first end and a second end, said first and second ends being attachable together to form a loop.

4. The cargo sling device of claim 2 wherein said one-piece elastic construction comprises no edge-mounted reinforcement elastic bands.

5. The cargo sling device of claim 1 wherein said removably attachable strap comprises a height dimension of about ten inches.

6. The cargo sling device of claim 1 wherein said exterior pocket comprises a fastener for closing said exterior pocket.

7. The cargo sling device of claim 1 wherein said removably attachable strap comprises said at least one exterior pocket for holding said second item of interior cargo, wherein said second item of interior cargo comprises an electronic device held in a vertical and accessible position to a driver of a vehicle.

8. The cargo sling device of claim 3 wherein said removably attachable strap comprises at least one fastener.

9. The cargo sling device of claim 8 wherein said at least one fastener comprises at least one zipper.

10. The cargo sling device of claim 9 wherein said at least one zipper is used to couple said first end and said second end of said removably attachable strap.

11. The cargo sling device of claim 7 wherein said at least one front exterior pocket comprises hook and loop fasteners on one side of said front exterior pocket such that said driver may access said electronic device from a driver's seat.

12. The cargo sling device of claim 1 wherein said removably attachable strap is a first removably attachable strap and further comprising:
a second removably attachable strap disposed adjacent said first removably attachable strap.

13. The cargo sling device of claim 12 wherein said second removably attachable strap is disposed in a stacked relationship with said first removably attachable strap.

14. The cargo sling device of claim 12 wherein said second removably attachable strap is disposed adjacent said first removably attachable strap on an exterior of said first removably attachable strap to form a second securing pocket between the first and second removably attachable straps.

15. A cargo sling device comprising:
a removably attachable strap being made from pliable material suitable to fit around a perimeter of a vehicle seat back wherein said seat back extends vertically through said removably attachable strap;
wherein said removably attachable strap comprises a one-piece elastic construction having a profile such that said removably attachable strap comprises a height of less than half of said seat back, said one-piece elastic construction having no edge-mounted horizontal reinforcement elastic bands;
wherein said removably attachable strap comprises a height dimension of about ten inches;
wherein said removably attachable strap forms a securing pocket in combination with said seat back and a seat cushion;
wherein said removably attachable strap comprises said at least one front exterior pocket having a hook and loop fastener for accessibly-holding a second piece of interior cargo, wherein said second piece of interior cargo comprises an electronic device held in a vertical and accessible position to a driver of a vehicle; and
wherein said removably attachable strap is used to elastically restrain at least one item of interior cargo in said securing pocket, said item of interior cargo set adjacent said seat back on said seat cushion.

16. The cargo sling device of claim 15 wherein said cargo sling device comprises a kit having said removably attachable strap, and at least one front exterior pocket.

17. A method of using a cargo sling device to secure at least one piece of interior cargo comprising the steps of:
installing a removably attachable strap around a perimeter of a vehicle seat back, wherein said removably attachable strap includes at least one exterior pocket; and
inserting and elastically-securing said at least one piece of interior cargo in said cargo sling device.

18. The method of using a cargo sling device of claim 17 wherein said installing step includes zipping a first and a second end of said removably attachable strap into a coupled relationship suitable to elastically-secure said at least one piece of interior cargo.

19. The method of using a cargo sling device of claim 17 further comprising accessibly-securing an electronic device into the exterior pocket via a hook and loop fastener.

20. The method of using a cargo sling device of claim 17 further comprising the step of removing said cargo sling device from said vehicle seat back and storing in a folded condition.
